(19) United States
(12) Patent Application Publication
(10) Pub. No.: US 2004/0069826 A1
(43) Pub. Date: Apr. 15, 2004

(54) Positional holder for retaining a cylindrical or semi-cylindrical device

(75) Inventor: Scott J. Neil, Portsmouth, VA (US)

Correspondence Address: GUERRY LEONARD GRUNE, 784 VILLIER CT., VIRGINIA BEACH, VA, 23452, US

(73) Assignee: Scott Neil, Portsmouth, VA

(21) Appl. No.: 10/458,771

(22) Filed: Jun. 10, 2003

Related U.S. Application Data
(60) Provisional application No. 60/388,068, filed on Jun. 11, 2002.

(51) Int. Cl. B60R 7/00; B60R 9/00; B60R 11/00

(52) U.S. Cl. 224/543; 224/550; 224/552

(57) ABSTRACT

The present invention includes a device that positions and holds a cycle or cycle-like vehicle or potentially a gas cylinder or aircraft gear or any cylindrical or semi-cylindrical device in a desirable position with a means for additionally securing the positioning and holding arrangement by use of a lock or locking mechanism. The positioning and holding device can retain the vehicle for an indefinite period of time and provides for a safe, quick, and efficient means for holding a tube or tube-like fork suspension and steering portion of the vehicle. Specially designed center and rear cushions complete with an actuator and connecting means allows for precision alignment during the positioning and subsequent holding action. The positional holder was originally designed for motor-cross (MX) motorcycles, but the present invention has also been designed for bicycles, street motorcycles, aircraft gear, compressed air cylinders and basically any device which requires a semi-circular positioning and holding mechanism.

### CLAIM TO PRIORITY

Applicant hereby claims priority under all rights to which they are entitled under 35 U.S.C. Section 120 based upon the U.S. Provisional Application Ser. No. 60/388,068 for this patent application filed at the United States Patent and Trademark Office on Jun. 11, 2002.

### FIELD OF INVENTION

This invention relates to a device that holds a cylindrical or semi-cylindrical device, such as a multi-wheeled vehicle, in a desirable position for an indefinite desired amount of time. More specifically, the present version of the invention is a holder for a motorcycle and even more specifically for a motor-cross or MX motorcycle that is specifically designed for off-road or “dirt” racing. The basic invention, however, includes other versions of the present design that also includes a similar device customized for conventional or “street” motorcycles, as well as essentially all known bicycle designs. The device in adapted form could be applied to quick release applications in the aircraft and safety industries. Additionally, the device is easily adapted to secure compressed gas cylinders or any other cylindrical items in a variety of industrial, commercial or consumer industries.

### BACKGROUND OF THE INVENTION

Conventional brackets or clamping arrangements for carrying cycles are previously known in this art and include gripping members designed as non-rigid plastic pieces abutting against approximately semi-cylindrical surfaces or hose shaped profiles in the clamps. Gripping jaws which are shaped to receive the tubes or fork of bicycles or motorcycles may cause damage to these portions of the vehicle due to the need to exert pressure on these portions of the motorcycle or bicycle to increase gripping strength. As pressure is increased, the potential for damage also increases in a somewhat linear fashion.

If the channels of the above-mentioned profile bodies of the grippers for the clamps are filled with a substantially rigid or slightly yieldable body, the configuration of the gripping members can be modified such that these will become adapted for fixed retention of slimmer tubes or a smaller fork in that the above-mentioned semi-cylindrical or hosed-shaped profiles can no longer be clamped together to the flat state.

In certain cases, the construction described above may perform well, but in cases when the bracket must be rapidly readjusted in order to be able to grasp between tubes of different dimensions, problems arise in that pins which are used for filling out the semi-cylindrical or hose shaped profiles readily become jammed in the profiles so that they cannot be released without resorting to auxiliary implements. A further considerable drawback is that the filler pins are loose details which are not reliably available when they are needed. A further disadvantage inherent in the prior art construction resides in the fact that the adjustment range which can be achieved by employing the above-mentioned semi-cylindrical or hose profiles and filler pins is very limited.

An object of the present invention is to realize a holding device designed in such a manner that it has a relatively large adjustment range that is not dependent upon loose small parts for its function, and that, moreover, it makes for an extremely reliable fixed retention of the cycle fork or other reasonable approximation of other vehicles with similar front steering and suspension means.

Another object of the invention is to the use the same or essentially the same device for holding gas cylinders for use in laboratories, hospitals, emergency vehicles and the like. The holder can easily be adapted to hold essentially any device that has geometric similarity to the clearance channel created between the center cushion and rear cushion sections. It is highly probable that the holding device can be used to hold landing gear of aircraft in place as well as tools in worksheds, kitchen appliances and utensils, etc.

In one embodiment of the present invention, a cycle is positioned so that the mechanical holder is engaged between the tubes comprising the fork of the motorcycle. This allows for a handle of an actuator to be pivoted or rotated to secure the motorcycle fork by essentially locking the holder in position without directly applying pressure to the fork. The holding device is not a clamp in the sense that a clamp implies continuous application of pressure on the object to be clamped and also implies that as the pressure on that object is increased, the ability to hold that object increases. Clamps, however, fail by at least two known mechanisms. First, as clamps are tightened, the pressure may exceed the yield strength of the object being clamped, thereby permanently damaging the object. Secondly, the clamp itself, after repeated uses, may become damaged by the repeated exertion of severe pressure such that a hysteresis-like cyclical effect on components of the clamp will occur. The holding device of the present invention has been specifically designed to avoid these pitfalls.

The device of the present invention is suitable for transporting, displaying, storing, maintaining, cleaning, preventing theft or simply holding a cycle or other vehicles with similar front steering means. The holder does not need to be closed to simply hold the cycle in place for storage purposes. For transportation purposes, however, the holder must be in the closed position to avoid any possible accidental release. Provisions, including the use of lock holes for the above mentioned locking requirement can be accomplished by the use of any conventional lock or other appropriate locking device. Again, this demonstrates how the holding device of the present invention differs from conventional clamping methods and means.

The present invention further has as an objective to realize a holder which is simple and economical in manufacture, permits rapid and convenient adaptation to all current vehicles, and will not cause damage to the portions of the tubes or fork held by this inventive holding device.

U.S. Pat. No. 6,109,494, of Pilmore, which issued Aug. 29, 2000, is directed to a mechanism for supporting a motorcycle for transportation purposes. A permanent bracket (60) is provided which, as noted in FIG. 1, included clamps (68a) and (68b) which have grooves that are positioned on opposite sides of the motorcycle frame members (12). As seen in FIG. 3, the bracket (60) is supported by a base (20) via a number of components which are not relevant to your invention. Pilmore's motorcycle support would appear to hold the suspension members in a state of tension when the motorcycle is being transported.

U.S. Pat. No. 6,179,181 B1, to Johnson et al, which issued Jan. 30, 2001, is directed to an adjustable bike transport rack adapted to be mounted on a truck bed. Except that is discloses a telescoping crossbar 10, this patent is not overly pertinent insofar as this invention is concerned.

U.S. Pat. No. 3,753,579, to Kurilich, Jr., which issued Aug. 21, 1973, is pertinent to the extent that it teaches carriage of motorcycles in a manner that their suspension systems are not impaired in any way. In fact, unlike the present invention, the suspensions of the motorcycles are allowed to operate freely and it is thus asserted that it is possible to eliminate the need for suspensions on the trailer, as such. The invention disclosed in this patent is in the public domain inasmuch as the patent has now expired.

U.S. Pat. No. 5,127,564, to Romero, which issued Jul. 7, 1992, is directed to a device for carrying a bicycle on the bed of a pick-up truck. You will note that this discloses an attachment bar (2) which connects to the sides of the truck. A bike holder tube (26) is connected to the bar (2). Two handle bar clamps (52) are also provided.

U.S. Pat. No. 5,203,484, to Englander, which issued Apr. 20, 1993, is directed to a clamping device, as such. The present invention does not provide the gripping members in the Englander patent which are adjustable to the frame tube involved. The rear cushions combined with the center cushion forming a “jaw-like” section does not involve adjustments of this type.

The need to improve cycle holders, reduce costs, and improve both holding ability and reduce potential damage to the cycles continues to exist.

### SUMMARY OF THE INVENTION

The present invention is a holding device specifically designed and developed for cycles. The shape of the holder is such that it initially fits between a front fork of a cycle and subsequently is spatially arranged to hold the front fork in a manner that is unknown in the prior art. The holding mechanism involves a center cushion that is shaped to closely and approximately fit between the tubes of a front fork assembly and two rear cushions that are mechanically aligned by an actuator to assure proper holding of each of two tubes comprising the fork assembly. A key provision for proper holding is the fact that the holder design encompasses a precision alignment that provides for clearance channels so that the cycle will remain stationary even when the holder comprised of these clearance channels is in an opened position. The opened position refers to the position of the rear cushions where they are initially spaced close to each other to accommodate essentially any fork of any cycle or multi-wheeled vehicle utilizing a similar front suspension and steering means. In the preferred closed position, the rear cushions are carefully and slowly expanded away from each other in a controlled fashion by an actuator such that intimate surface area contact with a large portion of the individual tubes with minimal or no pressure exerted is required to fix the fork assembly in a desired position which provides ultimate holding, positioning and retaining strength. In a less desirable configuration, there is more pressure exerted between contact areas at greater than three points between the tubes of the fork assembly and the walls of the clearance channels.

FIGS. 1 and 2 illustrate the complete holder assembly mounted to different support bars. The support bar shown in FIG. 2 is part of a mounting system for an enclosed trailer, while the support bar shown in FIG. 1 is very short and is shown so that it is fully understood how the support bar and the mechanical holder are coupled. For various types of installations, the crossbar could be considerably longer and may have either bends or angles welded in. The holding device in FIG. 1 is shown in both the opened and closed positions. Close inspection of FIG. 1 shows the lighter gray sections of the actuator handle and the two rear cushions indicating an opened position of the holding device. The motion of both the handle and the rear cushions can be followed by the drawn arc connecting the light gray section to the darker identical portions of the handle and rear cushions of the holding device.

FIG. 2 shows the same holding device with a different support bar, where the holding device is only in the closed position. Again, it is emphasized, although not shown in FIG. 2 that in the opened position, the holding device is still sufficient to prevent motion of the cycle without closing the rear cushions by mechanically using the actuator handle to separate the rear cushions. The action and direction of the rear cushions is actually in opposition to the common action associated with clamps or brackets known well in the prior art. Typical clamps draw toward each other to provide squeezing or holding pressure for the intended device, whereas the present invention is intended for holding and locking only by simple geometric dimensions. Stability is accomplished by locking the rear set of cushions attached to the housing.

This positioner and holder device for retaining multi-wheeled vehicles and in particular for retaining motorcycles and bicycles will be capable of being utilized with box vans, tractor trailers, enclosed trailers, open-sided trailers, pick-up trucks, etc. during transport. For stationary purposes, the holder can be used with walls, workbenches, and for free standing display of the vehicle. In an alternative embodiment, the positioner and holder can provide use for trailer hitch receivers with platforms for tires.

The benefits and advantages of this novel positioner and holder device can be summarized as follows;

The holder, by design, provides for less stress on the individual tubes and fork assembly of the multi-wheeled or cycle vehicles. During long periods of travel, the stress caused by vibration and other uncontrolled motions using conventional tying or clamping means may lead to excessive damage. A hysteresis effect can occur to individual components of conventional clamps and tying arrangements as the travel time during transportation is increased.

The holder is designed to be very light weight, allowing the user ease of convenience and providing for quick attachment of both the cycle and the mechanical positional holder to the body of a trailer or a wall or a workbench, etc. In addition, the light weight again reduces stress associated with holding the vehicle in place around the tubes and fork assembly suspension and steering means.

The holder may be removed with no tools, as a quick release type system is optional and the actuator described can be operated by hand.

The holder is extremely strong as demonstrated below in FIGS. 4, 5, and 6 by the destructive test techniques used to try to destroy the holder and its various components. It is probable that the holder will provide protection beyond that of any other known holding, clamping, or retaining means.

It is possible to secure the vehicle to the holder by introducing a lock or sets of locks either through the housing, the internal mechanism and center cushion or in other desirable locations including the support bar.

Stability and simplicity are additional key characteristics of the positioner holder as well as ease of use and the speed with which the holder can be attached to and detached from the fork portion of the cycle. All of these benefits have been realized in the prototype manufacture of the holder device over that of any other commercially available or otherwise known device to be used for the same or similar purposes.

Another important attribute is the fact that the holder device is convenient and there is no need to loosen the device overnight, as with more conventional holding means. For dirt bike racing, after a long hard day of actual racing, the owner likes to store his or her motorcycle in a safe and quick manner and then not open the trailer again until at least the next day. This holder device allows this convenience. The holder has a professional appearance with polishing and colors that match the drivers' desires and thus presents a better image to sponsors of the races and to the public in general. Conventional means such as straps and the like provide poor visual images for anyone associated with or exposed to the use of such a transporting or stationary holding means. As alluded to above, there is virtually no chance for loss due to damage of the vehicle being positioned and held during transport and the holder allows for much tighter spacing compared to conventional straps.

For motorcycles it has already been demonstrated that they travel better with the positioner and holder device. The rake angle of the front fork assembly is relaxed and the suspension is allowed to function normally which creates less bounce due to vibration and movement in transport. The undesired movement of the vehicle during transport is nearly eliminated.

The market for such devices is proportional to the roughly 91,000 registered AMA competitors in the U.S. alone. This product will also work on bikes used for trail riding and hare scramble riding. The application will eventually extend to include certain street bikes and possibly bicycles. Due to the fail-safe nature and instant release of this assembly, it may also be utilized in slightly modified form as a quick release device for aircraft or aircraft landing gear and possibly for gas cylinders.

The design may also be adapted for use in safety equipment, such as blocking mechanical devices from moving, or locking them open. Ladder racks for service trucks and vans is another potential use for this device.

Securing compressed gas cylinders in ambulances and in other various medical applications or laboratories is another foreseen application for this device. Other compressed gas cylinder applications include, but are not limited to welding gas cylinders, refrigeration containers and cylindrical fuel cells or other cylindrical components on or in aircraft.

Several quick release devices could also be replaced or newly developed by use of the present invention.

This invention provides a lower cost, fail-safe holding means for multi-wheeled vehicles, in particular cycles such as motorcycles and bicycles that must be transported or to be held in a stationary position for various purposes.

Various shaped sections of the center and rear cushions can be envisioned with the primary purpose remaining that the front steering means of the vehicles or cycles can be held securely and precisely without damage while maintaining a low cost to the consumer.

Other desired embodiments, results, and novel features of the present invention will become more apparent from the following drawings and detailed description and the accompanying claims.

### BRIEF DESCRIPTION OF THE DRAWINGS

FIG. 1 is a perspective view of one embodiment of the mechanical positional holder of the present invention that includes a support bar primarily to be used as part of a mounting system for an enclosed trailer that illustrates the holder in an opened and closed position.

FIG. 2 is also a perspective view of one embodiment of the mechanical positional holder that includes a simpler version of a support bar that could be used for other installations and that illustrates the holder in a closed position only.

FIG. 3 is an exploded view of one embodiment of the mechanical positional holder that includes all of the components required to assemble such a device in an efficient manner. Each component is labeled to allow for the detailed description given below.

FIG. 4 is a photograph of a test hoist apparatus for the mechanical positioner and holder device with a travel trailer in the background complete with a digital scale to measure the weight that the device will hold under stress.

FIG. 5 is the same as FIG. 4 with a wide-angle view of the same test hoist apparatus.

FIG. 6 is a photograph of a similar test apparatus as shown in FIGS. 4 and 5 except that the positioning and holder device is attached to a motorcycle that is suspended above ground by the hoist apparatus.

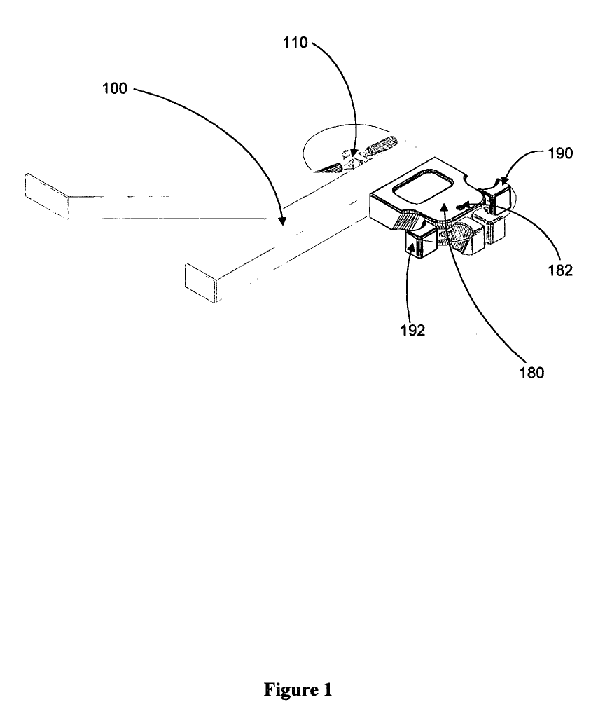

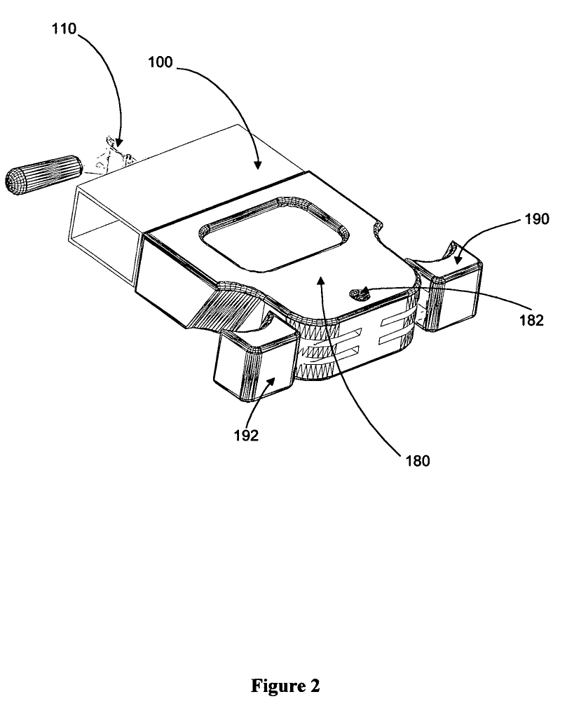

### DETAILED DESCRIPTION

The following description will further help to explain the inventive features of the mechanical holder and the method associated with holding multi-wheeled vehicles such as motorcycles and bicycles.

There are significant differences between this device and a clamp, although both perform a similar task. A clamp typically implies the use of crushing force. This device does not create enough pressure on the somewhat delicate fork tubes to cause distortion. It simply creates critical dimensions nearly exactly, in a positive manner, to use the strength of the front suspension and steering components to create a solid connection between the method of transportation (truck or trailer) and the cycle or multi-wheeled vehicle. The holding device prevents the forks of the cycle from going backwards, and the center cushion keeps the cycle from going either forward or side to side.

The holding device mechanism is created by set up in an over-center, compound linkage arrangement for fail-safe operation.

Because of the design, even if one of the actuation components did fail, such as one of the pivot pin placement section (140, for example), the holding device mechanism would still not open unless the actuator (110) was released. The current actuator is an over-center locking device itself, so the device actually has double over-center locking protection.

The purpose of the actuator (110) is to move the yoke assembly (120 and 122). The central pin (132) guides the yoke which is located in the center of the housing (130). The yoke maintains the distance between one end of each link (160 and 162). The other end of each link is connected to two levers on each side (142, 144, 146, and 148). The levers pivot around a very strong main pivot (152 and 154) on each side which is attached through holes in the forward edges of the housing. The link is primarily responsible for opening the levers (142, 144, 146, and 148), not closing them.

Additionally, the design of the interface between the yoke, the link and the lever mandates that the yoke is moved at least 9.5 millimeters before the lever can rotate 1 degree toward the complete closed position. The yoke creates a solid wedge between the levers. This wedge must be moved out from between the levers before the levers can move at all, providing additional safety in terms accidental release even under extremely high force.

The detailed description below represents a prototype and therefore only one embodiment of the present invention. Other variations of the prototype are also in development so that this description of this embodiment serves to enable understanding of the invention but not restrict the invention to specifically this embodiment only.

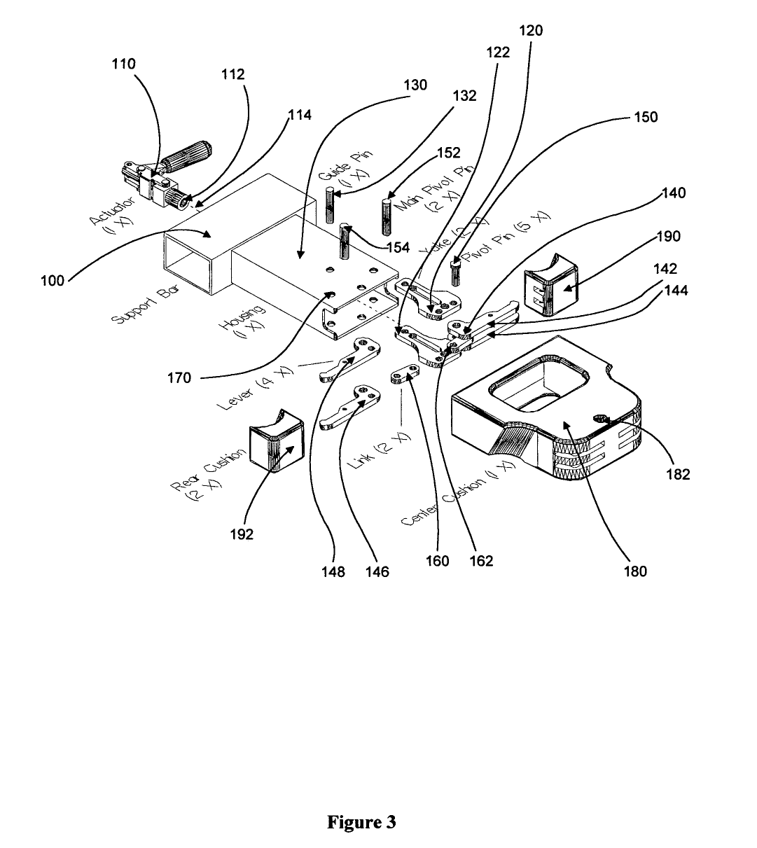

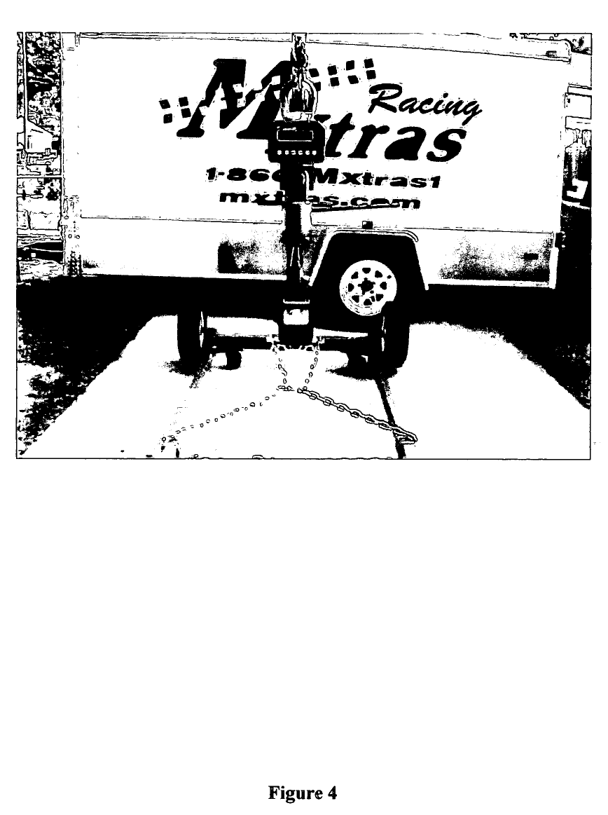

Referencing the exploded view shown in FIG. 3, the following is a description of each component and its function for ensuring proper operation of the mechanical positional holding device.

The Actuator

There is one actuator (110) per assembly. The body of the actuator is secured by a large lock nut (112) on the interior of the support bar and the moveable end is attached to a connector via a threaded connection. The actuator serves four key purposes.

Primarily, the actuator provides the mechanical means required for actuating the holding device. Internally, the actuator body is connected to the support bar, and to a plunger, or the object that is indirectly moved by the handle which is threaded onto a connector.

Second, the actuator provides security by offering a location for a locking device. A padlock hasp secured over the central link of the actuator prohibits operation of the actuator and therefore, operation of the holding device.

Third, the actuator supplies a second over-center locking arrangement to further ensure the device does not accidentally release, even under tremendous force. (It is coupled to the device by means of an internal thread to an adjustable connector).

Fourth, the position of the handle on the actuator supplies a second visual lock indicator.

The Connector

There is only one connector per assembly. The connector attaches the actuator to the yoke. One end is threaded into the actuator, and the other end is pinned to the small ends of the yokes. The dotted line in FIG. 3 (114) illustrates how the connector will attach the moveable end of the actuator's lock nut (112) to the yoke within the housing (130). The connector serves two purposes.

Primarily, the connector attaches the actuator (110) to the yokes (120 and 122) to convey the required mechanical movement to the device.

Second, the connector allows for adjustment of the device to accommodate all of the deviations in the manufacture of all of the components in the assembly.

The Yokes

There are two yokes (120 and 122) per assembly. The yokes are attached to the connector at the narrow end and the links (160 and 162) at the larger end. A slot in the center of their length combined with the guide pin provides straight, centered motion of the yokes.

The yoke serves seven functions.

Primarily, the yoke transmits the required actuation motion to the mechanism.

Second, the yoke provides a solid “wedge” between the levers once the unit is approximately 85% closed providing a nearly indestructible locked mechanism.

Third, the yoke also creates an over-center linkage arrangement to further create a positive, self-holding lock.

Fourth, the yoke also has provisions for internal guiding to keep the mechanism centered and equally actuated. This alignment helps relieve the alignment burden from the actuator.

Fifth, the yoke also provides a visual locking indicator by means of a hole for alignment at the end of the yoke indicating that the housing (130), center cushion (180) and yoke (120 and 122) are all properly aligned in a position for completion of locking.

Sixth, the yoke also provides for security. A padlock can be applied through a hole (182) at the end of the yoke, the center cushion and the housing with the unit in the fully locked position.

Seventh, the yoke creates critical dimensions for the correct operation of the linkage arrangement.

### The Support Bar(s)

There must be at least one support bar structure (100) per assembly. The support bar is a section of structural aluminum tubing either bent or welded to obtain the appropriate shape for the specific application. The support bar serves four purposes.

Primarily, the support bar supplies a load path for the forces of transporting the vehicle secured to the holding device to the mode of attachment to the transporting vehicle, such as a truck or trailer, or in the case of freestanding arrangements, the ground.

Second, the support bar offers a convenient and secure mounting location for the actuator (110), in whatever configuration required for the specific application.

Third, the support bar offers a forward resting surface and motion limiting means for the elastomeric center cushion.

Fourth, the support bar supplies a mounting structure for the holding device.

The Housing

There is one housing (130) per assembly. The housing is pre-fabricated and then welded to the support bar (100). The housing serves seven purposes.

Primarily the housing provides a structure and a mechanical platform for the internal mechanism of the holding device.

Second, the housing provides a structure on which to mount the center cushion (180).

Third, the housing establishes and maintains the critical distance ultimately utilized by the interface between the center cushion and the tubes of the fork of the transported vehicle.

Fourth, the housing provides a surface on which shims may be applied to allow a single center cushion to be adapted to a wide variety of front suspension steering systems.

Fifth, the housing also locates and supports the pivot pins (150, for example) about which the levers (142, 144, 146, and 148) may rotate.

Sixth, the housing also locates and supports the guide pin (132), which assists in keeping the yoke (120 and 122) on center.

Seventh, the housing also provides for security. A padlock can be applied through a hole at the end of the housing (182), the center cushion and the yoke with the entire holding device unit in the fully locked position.

The Links

There are two links (160 and 162) per assembly. One end of each link is connected to the yoke (120 and 122) and the other end to a lever (142, 144, 146, and 148). Pivot pins (150, for example) provide the connection. The link serves two purposes.

Primarily, the link provides the means for the mechanism to open. The closing of the device is not dependent on the link but the link does provide that motion as well.

Second, the link creates critical dimensions for the correct operation of the linkage arrangement.

The Levers

There are four levers (142, 144, 146, and 148) per assembly. Each lever is connected to the link via the pivot pin (150, for example). The main pivot pins engage the housing (130) to provide an axle about which the lever rotates. The rear cushion mounts to each pair of levers. The levers serve four purposes.

Primarily, the lever provides and maintains the closure dimension to keep the transported vehicle in place.

Second, the lever also provides a mounting configuration for the rear cushions (190 and 192).

Third, the lever creates a critical pivot dimension for the correct operation of the linkage system.

Fourth, the position of the levers can also be used to judge the closure of the device.

The Rear Cushions

There are two rear cushions (190 and 192) per assembly. The cushions are attached to the levers (142, 144, 146, and 148) by means of a positive locking geometric configuration. The rear cushion serves four purposes.

The primary function of the rear cushion is to transmit the closure force created by the lever to the transported vehicle in a manner that will not damage the vehicle.

Second, the rear cushion creates an angled, concave surface that nearly duplicates the portion of the vehicle in which it contacts (the forks), and is made of a very durable, elastomeric material that will not damage the vehicle's components.

Third, the elasticity of the elastomer and the configuration of the interface between the lever and the rear cushion help to retain the cushion.

Fourth, the elastomeric properties of the rear cushion allow the vehicle's rear suspension to operate on a slightly reduced capacity to absorb much of the force generated during transportation.

The Center Cushion

There is one center cushion (180) per assembly. This cushion fits over the housing with the levers (142, 144, 146, and 148) protruding from the face. It is retained by its elastomeric properties as well as by the ends of the guide pin (132) and main pivot pins (150, for example). The center cushion serves nine purposes.

Primarily, the center cushion creates an angled, concave surface that nearly duplicates the portion of the vehicle in which it contacts (the tubes of the forks), and is made of a very durable, elastomeric material that will not damage the vehicle's or cycle's components.

Second, the center cushion occupies very critical spacing between the tubes of the fork, which provides the majority of the stability of the holding method.

Third, the elastomeric properties of the center cushion allow the vehicle's rear suspension to operate in a reduced capacity to absorb much of the force generated during transportation.

Fourth, the center cushion creates somewhat of a seal to shield the consumer from the pinch potential of the internal mechanism.

Fifth, the center cushion creates a shield to protect the mechanism from the environment in which it will be exposed.

Sixth, the center cushion has provisions for retaining the shims which will adapt the width of the cushion to numerous applications.

Seventh, the hole (182) in the front, center of the center cushion assists in providing a visual locking indicator.

Eighth, the center cushion has provisions for security. A padlock can be applied through a hole (182) at the end of the center cushion, the yokes (142, 144, 146, and 148) and the housing (130) with the unit in the fully locked position.

Ninth, the center cushion is sized so that the application of the padlock will be free from damaging fretting of the housing and yokes because the center cushion will grip the hasp of the lock and therefore minimize its ability to move and rattle.

The Retaining Rings

There are six retaining rings (170, for example) per assembly. Each main pivot has one retaining ring on each end, as does the guide pin. The retaining rings serve only to retain the main pivot pins and the guide pin in the housing.

The Pivot Pins

There are five pivot pins (150, for example) per assembly. The pins are located at each of the smaller pivot points and connect the yoke to the link and the link to the lever. An additional pivot pin is used to attach the connector to the narrow end of the yoke. The pivot pins serve only to provide a pivot point for the internal linkage.

The Main Pivot Pins

There are two main pivot pins (152 and 154) per assembly. The main pivot pins engage the housing, passing through the levers (142, 144, 146, and 148) and the spacers and are retained by the retaining rings (170, for example) at both ends outside the housing (130). The main pivot pin serves two purposes.

Primarily the main pivot pin provides a structural pivot point for the lever.

Additionally, both ends of each main pivot pin assists in retaining the center cushion (182). The center cushion has subtle depressions on the interior surfaces, which engage the protruding ends of the pins.

The Guide Pin

There is one guide pin (132) per assembly. The guide pin engages the housing (130), passing through the guide slots in the yokes (120 and 122) and is retained by the retaining rings at both ends outside the housing. The guide pin serves two purposes.

Primarily, the guide pin locates and guides the yoke internally to keep the mechanism on center and operating smoothly.

Additionally, both ends of the guide pin assists in retaining the center cushion. The center cushion has subtle depressions on the interior surfaces, which engage the protruding ends of the pins.

The Spacers

There are four spacers per assembly. These go over the main pivot pins and between the housing and the lever assembly. The spacer serves only two purposes.

Primarily, the spacer keeps the assembly on center in the vertical plane.

Additionally, the spacer provides a smooth, self-lubricating surface to ensure the levers move freely and smoothly without galling.

The Glide Washers

There are ten glide washers in each assembly. These are used at all pivot locations. The glide washer serves four purposes.

Primarily the glide washer promotes free and smooth motion of the assembly. Second, the glide washer eliminates material galling at each pivot point. Third, the glide washer allows for a rattle free assembly. Fourth, the glide washer acts to seal lubrication in and dirt out of each pivot location.

The Shims

There are a various number of shims in each assembly. The shims fit between the housing and the center cushion and are held in place by the elastomeric properties as well as the configuration of the center cushion. The shim serves one purpose. The shims are used to allow a minimal number of cushions to accommodate all variations of different groups of vehicles, such as motorcycles, bicycles, aircraft, and the like.

There are numerous attachment methods using the support bar or bars previously described that are workable. At least three concepts exist, one of which involves mounting the device in an enclosed trailer and allowing the support bar to pivot out of the way when not in use with a semi-permanent hinge design. Another, more permanent design includes the use of a flange arrangement. A third design includes the use of cleat system, where a receiving portion of the cleat would be mounted to a body and the protruding engaging member would mate with the receiving portion.

In addition to the advantages described above in using this novel design, the positioning and holding device of the present invention has been tested to determine the strength of the support and what threshold levels can be achieved before rupture is accomplished. The destructive testing procedures are described below in order to demonstrate the effectiveness of this arrangement over that of any other known arrangement in use today or in the past.

### INITIAL PARTIAL DESTRUCTIVE TESTING

Conditions—135 mm, 1.75×4″ hand cut housing, routed long levers, standard routed links, R-1 routed center link (+2 mm actuation), ⅜″ low carbon steel main pivot pins retained by E clips, 5/16″ low carbon steel secondary pivot pins, no locking lever in place but the mechanism was locked and allowed to unlock if possible, no top or bottom reinforcement plates were provided.

The housing was chained to an engine hoist lift arm via two 7/16″ bolts through the back of the housing. The levers were chained to legs in a manner that centrally pulled the levers straight down without angular influence. The legs of the hoist were witnessed pulling inward therefore they were blocked apart.

The hoist was incapable of breaking the unit in the 1500-pound lifting point of the hoist.

The low carbon steel main pivot pins were forced to bend directly outward until the outer edge of each lever contacted the inside edge of the housing. It was at this point that it was realized that the hoist was not capable of producing sufficient force to catastrophically destroy the unit. The unit was not rendered inoperative. The unit was not forced open during the test and could still be manually operated afterward even though the main pivot pins were very severely bent.

The unit was visibly damaged—the levers appeared to be slightly distorted, but it was actually the pivot pins that were damaged. There was no apparent damage to either the levers or the links.

This unit is marked with “1500+Lb, test #1”.

### Second Attempted Destructive Test

Conditions—135 mm, 1.75×4″ hand cut housing, 4× routed short levers, 2× standard routed links, 2×R-2 routed center links—now called Yokes (+0.5 mm actuation), ⅜″

Grade 8 alloy steel bolts used for main pivots, 5/16″ low carbon steel secondary pivot pins, no locking lever in place but the mechanism was locked and allowed to unlock if possible, no top or bottom reinforcement plates were provided.

Housing was chained to engine hoist lift arm via two 7/16″ bolts through the back of the housing. The levers were chained to legs in a manner that centrally pulled the levers straight down without angular influence. The legs of the hoist were blocked apart.

The hoist was incapable of damaging the unit in the 1500-pound lifting point of the hoist. This unit was held under tension for approximately 8 minutes.

After the test, the unit appeared to be completely undamaged. There were NO parts that showed signs of bending or damage. The unit actuation was as smooth as it was before the test, so that no adverse results were noted. Unlike the first test, this unit could be disassembled and examined. No noticeable damage was observed upon disassembly.

This unit is marked with “1500+Lb, test #2”.

### Third Attempted Destructive Test

Conditions—135 mm, 1.75×4″ hand cut housing, 4× routed short levers, 2× standard routed links, 2×R-2 routed Yokes (+0.5 mm actuation), ⅜″ Grade 8 alloy steel main pivots, ¼″ low carbon steel secondary pivot pins, no locking lever in place but mechanism locked—allowed to unlock if possible, no top or bottom reinforcement plates. The primary design difference of this unit from that of the first two units tested and described above is that the secondary pivots were all bushed from 5/16″ to ¼″ with flanged nylon bushings which created smoother motion and spaced the levers 2 mm from each link creating a slightly wider footprint to support the cushions.

The housing was chained to an engine hoist lift arm via two 7/16″ bolts through the back of the housing. The levers were chained to legs in a manner that centrally pulled the levers straight down without angular influence. The legs of the hoist were blocked apart.

The hoist was incapable of damaging the unit in the 1500-pound lifting point of the hoist. This unit was held under tension for approximately 22 minutes.

After the test, the unit appeared to be completely undamaged. There were NO parts that showed signs of bending or damage. The unit actuation was as smooth as it was before the test. Unlike the first test, this unit could be disassembled and examined. No noticeable damage was observed upon disassembly.

This unit is marked with “Test #3”.

### Fourth Attempted Destructive Test

Conditions—163 mm, 1.75×4″ machined housing, 4× machined standard levers, 2×standard machined links, 2×R-2 machined Yokes (+0.5 mm actuation), ⅜″ alloy steel main pivots, 5/16″ low carbon, solid steel rivets as secondary pivot pins, actuator lever in place and mechanism locked, no top or bottom reinforcement plates. The primary design difference of this unit from that of the first three units tested and described above is that the secondary pivots were all 5/16″ low carbon solid steel rivets. Flanged nylon bushings which created smoother motion and spaced the levers from each link creating a slightly wider footprint to support the cushions were in place as well as all glide washers.

This test was performed on what has become the standard production prototype of the device.

The housing was chained to an engine hoist lift arm via two 7/16″ bolts through the back of the housing.

A calibrated, digital scale was utilized in this test to verify the forces being applied through the device.

The levers were chained to legs of the hoist in a manner that centrally pulled the levers straight down without angular influence. The legs of the hoist were blocked apart to provide a very stiff platform.

Due to the large size of the hook on the digital scale, it was not possible to connect it to the hoist in the same location as previous tests. The previous tests were performed in the 1500 pound location, whereas this test was connected in-between the 1500 and 1000 pound limit locations, where the hoist produced a maximum of 1475 pounds of force. The design target strength for the device is 1400 pounds which is greater than six times the weight of the heaviest “dirt bike” in manufacture.

This unit held this tension for approximately 18 minutes.

After the test, the unit appeared to be completely undamaged. There were NO parts is that showed signs of bending or damage. The unit actuation of the levers as provided by the actuator was identical to that prior to the test. No noticeable damage was observed upon disassembly.

This unit is marked with “Test #4”. Again two photographs are provided. This test was video taped uninterrupted.

It will, of course, be appreciated that the embodiments which have just been described have been given simply by the way of illustration, and the invention is not limited to the precise embodiments described herein; various changes and modifications may be effected by one skilled in the art without departing from the scope or spirit of the invention as defined in the appended claims.

What is claimed is:

1. A positioner and holder for a semi-cylindrical device for one or more multi-wheeled vehicles comprising; an adjustable center cushion with a rear portion and a forward portion;
at least two rear adjustable cushions movably connected to said center cushion such that said rear portion of said center cushion can move to a forward portion of said center cushion, and;
where said center cushion is connected to a support bar, and;
where semi-circular sections exist on one side of each of said rear cushions such that said semi-circular sections face away from each other in an opened position and said semi-circular sections face toward said forward portion of said center cushion in a closed position, and;
where said semi-circular sections together with a curved portion of said center cushion forms clearance channels with inner and outer circumferential walls providing a proper dimension to position, hold, and retain at least one tube of a suspension and steering fork, and;
said fork comprising at least two of said retained tubes of said multi-wheeled vehicle.

2. The positioner and holder for a semi-cylindrical device of claim 1, wherein said multi-wheeled vehicle is a motorcycle.

3. The positioner and holder for a semi-cylindrical device of claim 1, wherein said multi-wheeled vehicle is a bicycle.

4. The positioner and holder for a semi-cylindrical device of claim 1, wherein said multi-wheeled vehicle is a portion of an aircraft such as landing gear for said aircraft.

5. The positioner and holder for a semi-cylindrical device of claim 1, wherein said support bar may be fastened to a body by the use of a mating flange system for permanent fixturing.

6. The positioner and holder for a semi-cylindrical device of claim 1, wherein said support bar may be fastened to a body by the use of a mated hinged system for semi-permanent fixturing.

7. The positioner and holder for a semi-cylindrical device of claim 1, wherein said support bar may be fastened to a body by use of a mated cleat system for removable fixturing.

8. The positioner and holder for a semi-cylindrical device of claim 1, wherein said formed clearance channels contact said tubes of said fork all along said inner circumferential walls of said clearance channels.

9. The positioner and holder for a semi-cylindrical device of claim 1, wherein said formed clearance channels at most contact said tube's of said fork at three points of contact.

10. The positioner and holder for a semi-cylindrical device of claim 1, wherein said formed clearance channels at most contact said tubes of said fork at two points of contact.

11. The positioner and holder for a semi-cylindrical device of claim 1, wherein said formed clearance channels at most contact said tubes of said fork at one point of contact.

12. The positioner and holder for a semi-cylindrical device of claim 1, wherein said clearance channels of said tubes of said fork do not contact the walls of said clearance channels.

13. The positioner and holder for a semi-cylindrical device of claim 1, wherein said center cushion and said rear cushions are comprised of elastomeric materials.

14. A system for positioning and holding a multi-wheeled vehicle by;
positioning tubes of a fork in a pre-manufactured center cushion such that semi-circular sections on one side of each of a set of rear cushions face away from each other in an opened position and said semi-circular sections face toward a forward portion of said center cushion in a closed position, and;
actuating said opened and closed positions with an actuator by pushing or pulling said actuator to accomplish said opened or closed position, and;
completing said system by locking said tubes of said forks in place using a mechanical, electro-mechanical, or optically-activated lock.

15. A positioner and holder for a semi-cylindrical device comprising;
an adjustable center cushion with a rear portion and a forward portion, and;
at least two rear adjustable cushions movably connected to said center cushion such that said rear portion of said center cushion can move to a forward portion of said center cushion, and;
where said center cushion is connected to a support bar, and;
where semi-circular sections exist on one side of each of said rear cushions such that said semi-circular sections face away from each other in an opened position and said semi-circular sections face toward said forward portion of said center cushion in a closed position, and;
where said semi-circular sections together with a curved portion of said center cushion forms clearance channels with inner and outer circumferential walls providing a proper dimension to position, hold, and retain a portion of said cylinder.

16. The positioner and holder for a semi-cylindrical device of claim 15, wherein said device is compact and available for use with medical equipment in a hospital.

17. The positioner and holder for a semi-cylindrical device of claim 15, wherein said cylindrical or semi-cylindrical device is compact and available for use with medical equipment in an ambulance.

18. A system for positioning and holding a gas cylinder by;
positioning tubes of a fork in a pre-manufactured center cushion such that semi-circular sections on one side of each of a set of rear cushions face away from each other in an opened position and said semi-circular sections face toward a forward portion of said center cushion in a closed position, and;
actuating said opened and closed positions with an actuator by pushing or pulling said actuator to accomplish said opened or closed position.

19. The system of claim 18, wherein said gas cylinder is a welding gas cylinder.

20. The system of claim 18, wherein said gas cylinder is a refrigeration container.

21. The system of claim 18, wherein said gas cylinder is a cylindrical fuel cell.

22. The system of claim 18, wherein said gas cylinder is an oxygen canister, or like cylindrical container, on an aircraft.

23. The system of claim 18, wherein said gas cylinder is compact and available for use with medical equipment.

24. A system for positioning and holding a gas cylinder by;
positioning tubes of a fork in a pre-manufactured center cushion such that semi-circular sections on one side of each set of rear cushions face away from each other in an opened position and said semi-circular sections face toward a forward portion of said center cushion in a closed position, and;
actuating said opened and closed positions with an actuator by pushing or pulling said actuator to accomplish said opened or closed position, and;
completing said system by locking said tubes of said forks in place using a mechanical or electro-mechanical, or optically-activated lock.

25. A system for positioning and securely holding cylindrically or semi-cylindrically shaped equipment by;
positioning a cylindrical component of the equipment in a pre-manufactured center cushion such that semi-circular sections on one side of each set of rear cushions face away from each other in an opened position and said semi-circular sections face toward a forward portion of said center cushion in a closed position, and;
actuating said opened and closed positions with an actuator by pushing or pulling said actuator to accomplish said opened or closed position, and;
completing said system by locking said cylindrical components in place using a mechanical or electro-mechanical, or optically activated lock.

26. The system of claim 25, wherein said cylindrically or semi-cylindrically shaped equipment being securely held is a ladder on a service truck or van.

27. The system of claim 25, wherein said holding cylindrically or semi-cylindrically shaped equipment being securely held is medical equipment in an ambulance.

28. The system of claim 25, wherein said holding cylindrically or semi-cylindrically shaped equipment being securely held is a gurney in an ambulance.

29. A device for positioning and securely holding cylindrically or semi-cylindrically shaped equipment by;
positioning a cylindrical component of the equipment in a pre-manufactured center cushion such that semi-circular sections on one side of each set of rear cushions face away from each other in an opened position and said semi-circular sections face toward a forward portion of said center cushion in a closed position, and;
actuating said opened and closed positions with an actuator by pushing or pulling said actuator to accomplish said opened or closed position, and;
completing said system by locking said cylindrical components in place using a mechanical or electro-mechanical, or optically activated lock.

30. The device of claim 29, wherein said cylindrically or semi-cylindrically shaped equipment being securely held is a ladder on a service truck or van.

31. The device of claim 29, wherein said holding cylindrically or semi-cylindrically shaped equipment being securely held is medical equipment in an ambulance.

32. The device of claim 29, wherein said holding cylindrically or semi-cylindrically shaped equipment being securely held is a gurney in an ambulance.
